(19) United States
(12) Patent Application Publication
(10) Pub. No.: US 2016/0216840 A1
(43) Pub. Date: Jul. 28, 2016

(54) Screen edge touch control optimization method, device and terminal

(71) Applicant: ZTE CORPORATION, Shenzhen (CN)

(72) Inventor: Jian Lei, Shenzhen (CN)

(21) Appl. No.: 14/908,998

(22) PCT Filed: Oct. 9, 2013
(86) PCT No.: PCT/CN2013/084893

§ 371 Date: Jan. 29, 2016

(30) Foreign Application Priority Data
Aug. 16, 2013 (CN) 201310360330.7

(51) Int. Cl. G06F 3/041; G06F 3/0488

(52) U.S. Cl. CPC G06F 3/0418; G06F 3/04886

(57) ABSTRACT

Disclosed is a screen edge touch control optimization method, including that a screen edge touch control optimization region is set, and when it is determined that a touch point detected currently is located in the screen edge touch control optimization region, a touch control event corresponding to the detected touch point is prohibited from being reported to an application layer. An embodiment of the present disclosure also discloses an edge touch control optimization device and a terminal. By adopting the technical solutions of the embodiments of the present disclosure, misoperation caused by touching an edge of a screen can be effectively avoided, and user experience is improved while good visual experience is brought to the user.

### TECHNICAL FIELD

The present disclosure relates to screen touch control technology, more particularly, to a screen edge touch control optimization method, device and a terminal.

### BACKGROUND

Large screen terminals supporting multipoint touch control have become very popular with the rapid development of touch screen technology and touch screen terminals larger than 6 inches have emerged. In order to minimize size of a terminal and maintain large screen at the same time, the terminal are generally designed with a narrow border. At present, it has been shown by available data that the narrowest border of a terminal is only 2.4 millimeters wide.

In the related art, although good visual experience has been brought to a user by using the technology for a terminal with a large screen and a narrow border, a new problem is also caused for a touch control operation of the user. Since the border of the terminal is extremely narrow, the roots of a finger and a thumb holding the terminal will inevitably touch an edge part of the screen when the user uses the terminal, thus causing misoperation. If a touch control event corresponding to the touch on the screen edge of the terminal is reported, a touch control operation on another region is not responded, thereby seriously affecting user experience.

### SUMMARY

In view of this, the major purpose of embodiments of the present disclosure is to provide a screen edge touch control optimization method, a device and a terminal, so that misoperation caused by touching an edge of a screen can be effectively avoided, and user experience is improved while good visual experience is brought to the user.

In order to achieve the purpose above, the technical solutions of the embodiments of the present disclosure are implemented as follows.

An embodiment of the present disclosure provides a screen edge touch control optimization method, including that a screen edge touch control optimization region is set, and when it is determined that a touch point detected currently is located in the screen edge touch control optimization region, a touch control event corresponding to the detected touch point is prohibited from being reported to an application layer.

Preferably, before it is determined that the touch point detected currently is located in the screen edge touch control optimization region, the screen edge touch control optimization method further includes that it is determined that a screen edge touch control optimization function is turned on.

Preferably, when it is determined that the touch point detected currently is located in the screen edge touch control optimization region, the screen edge touch control optimization method further includes that it is determined that an application activated currently is a preset application that needs to use the screen edge touch control optimization function.

Preferably, the operation that the screen edge touch control optimization region is set includes that more than one region with different areas is set in the screen as the touch control optimization regions.

Preferably, the screen edge touch control optimization method further includes that, when it is determined that the application activated currently is not the preset application that needs to use the screen edge touch control optimization function, the touch control event corresponding to the detected touch point is reported to the application layer to be processed.

An embodiment of the present disclosure further provides a screen edge touch control optimization device, including: a touch control optimization function setting unit and a touch control optimization execution unit, wherein

the touch control optimization function setting unit is configured to set a screen edge touch control optimization region; and

the touch control optimization execution unit is configured to, when it is determined that a touch point detected currently is located in the screen edge touch control optimization region, prohibit a touch control event corresponding to the detected touch point from being reported to an application layer.

Preferably, the touch control optimization function setting unit is further configured to set more than one region with different areas in the screen as the touch control optimization regions.

Preferably, the touch control optimization function setting unit is further configured to trigger the touch control optimization execution unit when it is determined that a screen edge touch control optimization function is turned on.

Preferably, the touch control optimization function setting unit is further configured to set an application that needs to perform screen edge touch control optimization processing; and

the touch control optimization execution unit is further configured to, when it is determined that the touch point detected currently is located in the screen edge touch control optimization region, determine that a current application is the application that needs to perform the screen edge touch control optimization processing.

Preferably, the touch control optimization execution unit is further configured to, when it is determined that an application activated currently is not the preset application that needs to use the screen edge touch control optimization function, report the touch control event corresponding to the detected touch point to the application layer to be processed.

Preferably, the touch control optimization function setting unit includes:

a touch control optimization function setting sub-unit, configured to set whether to turn on the screen edge touch control optimization function;

a touch control optimization region setting sub-unit, configured to set the screen edge touch control optimization region; and

a touch control optimization application setting sub-unit, configured to set the application that needs to perform the screen edge touch control optimization processing.

An embodiment of the present disclosure further provides a terminal, including the abovementioned screen edge touch control optimization device.

According to the screen edge touch control optimization method, device and terminal provided by the embodiments of the present disclosure, a screen edge touch control optimization region is set; when a touch point is detected, it is determined whether the detected point is located in the screen edge touch control optimization region, and if so, a touch control event corresponding to the detected touch point is prohibited from being reported to an application layer. In this way, misoperation caused by touching an edge of a screen can be effectively avoided, and user experience is improved while good visual experience is brought to the user.

### BRIEF DESCRIPTION OF THE DRAWINGS

FIG. 1 is a basic flowchart showing a screen edge touch control optimization method according to an embodiment of the present disclosure;

FIG. 2 is a detailed implementation flowchart showing a screen edge touch control optimization method according to an embodiment of the present disclosure;

FIG. 3a is the first schematic diagram illustrating the application effect of a screen edge touch control optimization method according to an embodiment of the present disclosure;

FIG. 3b is the second schematic diagram illustrating the application effect of a screen edge touch control optimization method according to an embodiment of the present disclosure;

FIG. 4 is a structural diagram of a screen edge touch control optimization device according to an embodiment of the present disclosure; and

FIG. 5 is a structural diagram of a touch control optimization function setting unit in a screen edge touch control optimization device according to an embodiment of the present disclosure.

### DETAILED DESCRIPTION

The basic idea of the embodiments of the present disclosure is that a screen edge touch control optimization region is set, it is determined whether a touch point detected currently is located in the screen edge touch control optimization region, and if so, a corresponding touch control event is not reported to an application layer.

Preferably, a switch for a screen edge touch control optimization function may be preset in the embodiments of the present disclosure. The screen edge touch control optimization function is turned on if necessary or before a screen touch point is detected. Accordingly, when it is determined whether the touch point detected currently is located in the screen edge touch control optimization region, it is determined whether the screen edge touch control optimization function has been turned on, and if so, processing of screen edge touch control optimization is performed.

Preferably, an application that needs to perform the processing of the screen edge touch control optimization may be preset in the embodiments of the present disclosure. Accordingly, when the screen touch point is detected, it is determined whether a current application is the application that needs to perform the processing of the screen edge touch control optimization, if so, the processing of the screen edge touch control optimization is performed, and otherwise, the processing of the screen edge touch control optimization is not performed.

It should be noted that a terminal described in the embodiments of the present disclosure is not merely limited to a smart phone, or a Personal Digital Assistant (PDA), but also includes players such as a Moving Picture experts group audio player 3 (MP3) and so on. In a word, all touch screen terminals capable of executing a screen edge touch control optimization method of the present disclosure should belong to terminals claimed in the present disclosure.

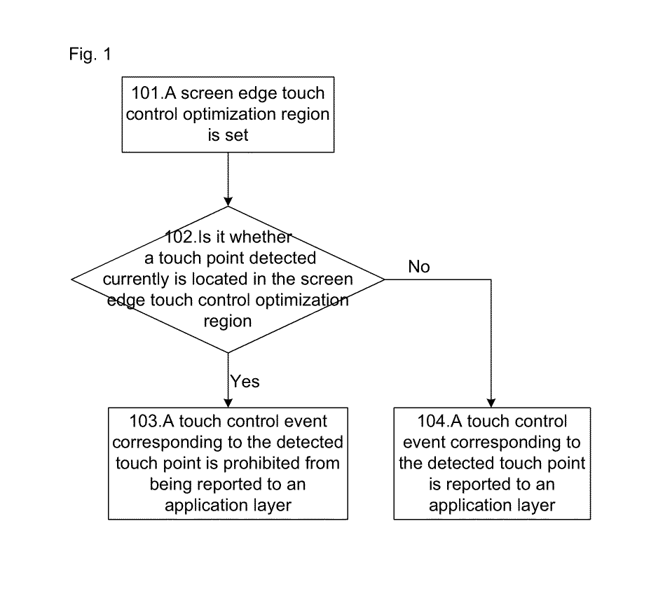

FIG. 1 shows a basic flowchart showing a screen edge touch control optimization method according to an embodiment of the present disclosure, including the following steps.

Step 101: A screen edge touch control optimization region is set.

Here, the operation that the screen edge touch control optimization region is set includes that more than one region with different areas is set as the touch control optimization region, wherein only one or two touch control optimization regions may be set as required, or more than two touch control optimization regions may be set. If a plurality of touch control optimization regions is set, the area of each touch control optimization region may be set as required in practice.

Step 102 to Step 104: It is determined whether a touch point detected currently is located in the screen edge touch control optimization region, if so, Step 103 is performed, and otherwise, Step 104 is performed.

Step 103: A touch control event corresponding to the detected touch point is prohibited from being reported to an application layer.

Step 104: A touch control event corresponding to the detected touch point reported to an application layer.

As a preferred embodiment, it is further determined that a screen edge touch control optimization function has been turned on before Step 102.

Here, the operation that the touch control event corresponding to the detected touch point is prohibited from being reported to the application layer may be implemented by means of performing optimized filtering to the touch control event. Processing performed after the touch control event is reported to the application layer is the same as that in the related art, and will not be described repeatedly here.

In a preferred embodiment, Step 101 further includes that a switch for the screen edge touch control optimization function is set. Accordingly, before whether the touch point detected currently is located in the screen edge touch control optimization region is determined, it is determined that the screen edge touch control optimization function has been turned on in Step 102.

In a preferred embodiment, Step 101 further includes that an application that needs to perform screen edge touch control optimization processing is set. Accordingly, it is determined whether a current application is the application that needs to perform the screen edge touch control optimization processing after the screen touch point is detected in Step 102, if so, Step 102 to Step 104 are performed, and otherwise, subsequent processing is performed according to the related art.

The technical solutions of the present disclosure will be further expounded below with reference to the accompanying drawings and specific embodiments.

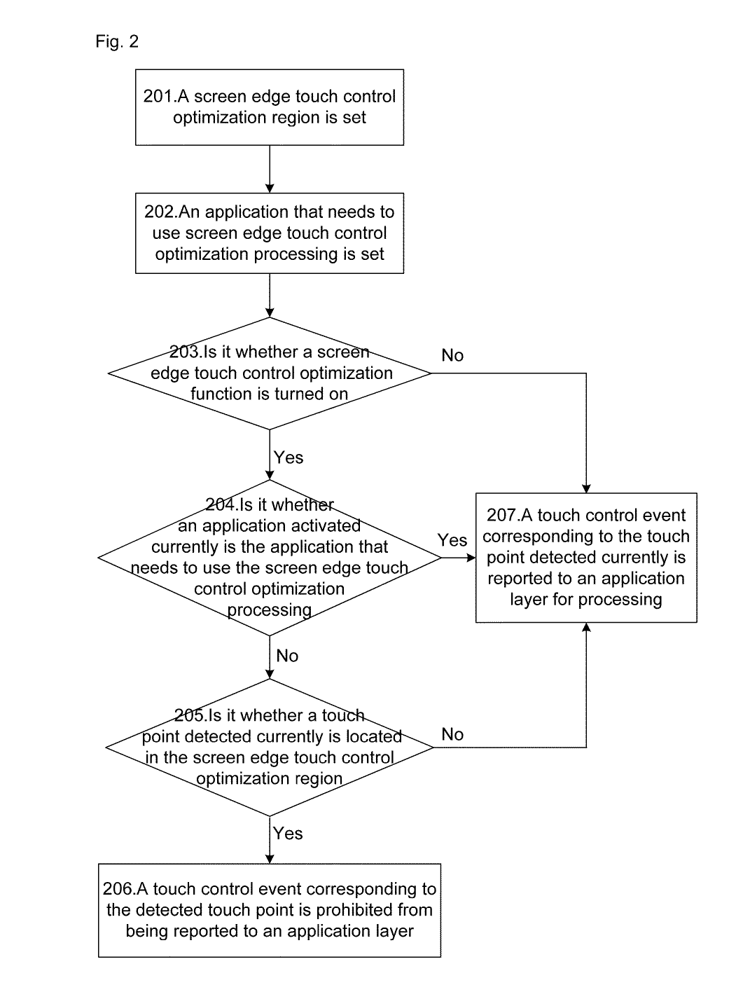

FIG. 2 is a detailed implementation flowchart showing a screen edge touch control optimization method according to an embodiment of the present disclosure, including the following steps.

Step 201: A screen edge touch control optimization region is set.

In this step, the screen edge touch control optimization region is a region for optimizing filtering to a touch control event. One or two touch control optimization regions may be set as required, or more than two touch control optimization regions may be set. If a plurality of touch control optimization regions is set, the area of each touch control optimization region may be set as required in practice.

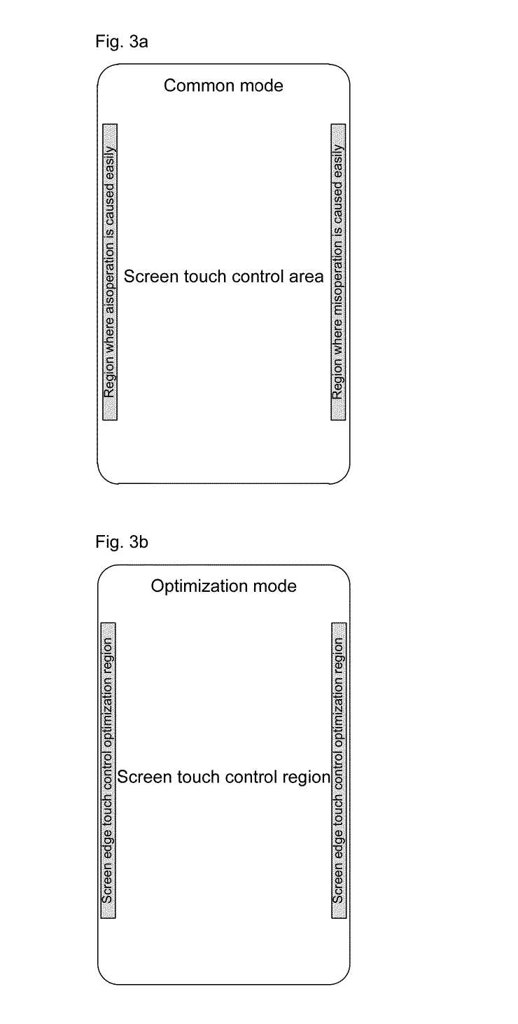

Here, an example of setting a screen edge region as a screen edge touch control optimization region is as shown in FIG. 3a and FIG. 3b. Regions as shown in FIG. 3a, where misoperation is caused easily at the leftmost side and the rightmost side of a screen, are set as screen edge touch control optimization regions as shown in FIG. 3b. In practical application, filtering to touch control events in the screen edge touch control optimization regions as shown in FIG. 3b may be optimized to effectively avoid misoperation.

Step 202: An application that needs to perform screen edge touch control optimization processing is set.

Here, since a touch control event of a full screen region needs to be processed when using some applications including gaming, drawing and so on, such applications are not set as applications that need to perform the screen edge touch control optimization processing. When a screen edge touch control optimization function is turned on, all touch control events corresponding to an application that does not need to use the screen edge touch control optimization function are reported to an application layer to be processed. In other words, it is unnecessary to filter the touch control events in an optimized manner.

As a preferred embodiment, touch control optimization regions are further set corresponding to different applications, and associations between the applications and the touch control optimization regions are set. Touch control optimization regions for different applications may be different.

Step 203: It is determined whether a screen edge touch control optimization function has been turned on, if so, Step 204 is performed, and otherwise, Step 207 is performed.

In this step, it is set according to an instruction from a user that the screen edge touch control optimization function is turned on when it is necessary to perform the screen edge touch control optimization processing, and it is set according to an instruction from the user that the screen edge touch control optimization function is turned off when it is unnecessary to perform the screen edge touch control optimization processing, wherein the screen edge touch control optimization function may be turned on or turned off at any moment according to an instruction from a terminal user.

Step 204: It is determined whether an application activated currently is the application that needs to use the screen edge touch control optimization processing, if so, Step 207 is performed, and otherwise, Step 205 is performed.

In this step, a touch control event in a full screen region is reported to an application layer to be processed without being filtered in an optimized manner when the current application is an application that does not need to use the screen edge touch control optimization processing.

When the current application is the application that needs to use the screen edge touch control optimization function, a touch control event in the screen edge touch control optimization region is filtered in an optimized manner subsequently.

Step 205: It is determined whether a touch point detected currently is located in the screen edge touch control optimization region, if yes, Step 206 is performed, and otherwise, Step 207 is performed.

Step 206: A touch control event corresponding to the detected touch point is prohibited from being reported to an application layer.

Step 206 includes that a touch control event in the screen edge touch control optimization region is filtered in an optimized manner according to the screen edge touch control optimization region set by a user, that is, the touch control event is not reported to an application layer.

Step 207: A touch control event corresponding to the touch point detected currently is reported to an application layer to be processed.

That it, instead of being filtered in an optimized manner, the touch control event is subjected to a subsequent operation according to the related art.

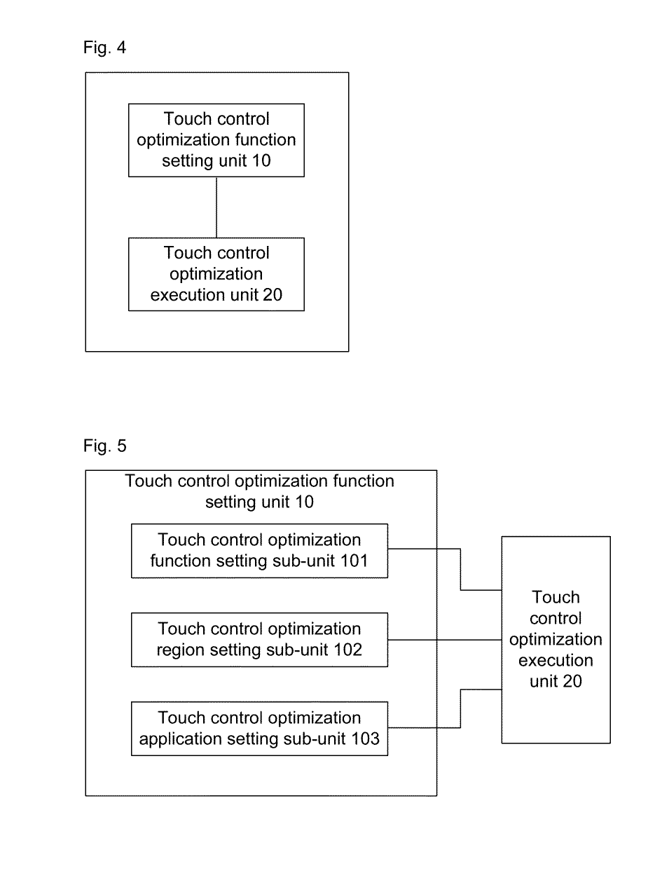

An embodiment of the present disclosure further provides a screen edge touch control optimization device so as to implement the screen edge touch control optimization method above. The screen edge touch control optimization device, which is arranged in a terminal, is a new screen edge touch control optimization functional module of the mobile terminal. FIG. 4 shows a structure of the screen edge touch control optimization device. The device includes:

a touch control optimization function setting unit 10, configured to set a screen edge touch control optimization region; and

a touch control optimization execution unit 20 configured to, when it is determined that a touch point detected currently is located in the screen edge touch control optimization region, prohibit a touch control event corresponding to the detected touch point from being reported to an application layer.

In this embodiment, the touch control optimization function setting unit 10 may set only one or two touch control optimization regions as required, or set more touch control optimization regions. If a plurality of touch control optimization regions is set, the area of each touch control optimization region may be set as required in practice.

In this embodiment, the touch control optimization function setting unit 10 is further configured to set more than one region with different areas in the screen as the touch control optimization regions.

In this embodiment, the touch control optimization function setting unit 10 is further configured to trigger the touch control optimization execution unit 20 when it is determined that a screen edge touch control optimization function is turned on.

In this embodiment, the touch control optimization function setting unit 10 is further configured to set an application that needs to perform screen edge touch control optimization processing.

The touch control optimization execution unit 20 is further configured to, when it is determined that the touch point detected currently is located in the screen edge touch control optimization region, determine that a current application is the application that needs to perform the screen edge touch control optimization processing.

The touch control optimization execution unit 20 is further configured to, when it is determined that an application activated currently is an application that does not need to use the screen edge touch control optimization processing, report the touch control event corresponding to the touch point detected currently to the application layer to be processed.

The touch control optimization execution unit 20 is further configured to, when it is determined that the application activated currently is the application that needs to use the screen edge touch control optimization processing, perform, according to the screen edge touch control optimization region set by the touch control optimization function setting unit 10, optimized filtering to a touch control event corresponding to a touch point detected in the screen edge touch control optimization region, i.e. the touch control event is not reported to an application layer.

FIG. 5 is a structural diagram illustrating the touch control optimization function setting unit 10 in an embodiment of the present disclosure, including: a touch control optimization function setting sub-unit 101, a touch control optimization region setting sub-unit 102 and a touch control optimization application setting sub-unit 103.

The touch control optimization function setting sub-unit 101 is configured to set whether to turn on the screen edge touch control optimization function.

When a user of the terminal needs to perform screen edge touch control optimization, the touch control optimization function setting sub-unit 101 sets, according to an instruction from the user, to turn on the screen edge touch control optimization function, and when the user of the terminal does not need to perform the screen edge touch control optimization, the touch control optimization function setting sub-unit 101 sets, according to an instruction from the user, to turn off the screen edge touch control optimization function. The touch control optimization function setting sub-unit 101 may further turn on or turn off the screen edge touch control optimization function at any time according to an instruction from the user of the terminal.

The touch control optimization region setting sub-unit 102 is configured to set the screen edge touch control optimization region.

Here, the screen edge touch control optimization region is a region for optimizing filtering to a touch control event. Only one or two touch control optimization regions may be set as required, or more touch control optimization regions may be set. If a plurality of touch control optimization regions is set, the area of each touch control optimization region is different may be set as required in practice.

The touch control optimization application setting sub-unit 103 is configured to set the application that needs to perform the screen edge touch control optimization processing.

Here, since a touch control event of a full screen region needs to be processed when using some applications including gaming, drawing and so on, it is unnecessary to set such applications as applications that need to use the screen edge touch control optimization function. When the screen edge touch control optimization function is turned on, all touch control events corresponding to an application that does not need to use the screen edge touch control optimization function are reported to an application layer to be processed. In other words, the touch control optimization execution unit 20 does not filter the touch control events in an optimized manner.

It should be noted that information set by the touch control optimization function setting sub-unit 101, the touch control optimization region setting sub-unit 102 and the touch control optimization application setting sub-unit 103 may be stored in a memory of the terminal. In practice, both the touch control optimization function setting unit 10 and the touch control optimization execution unit 20 may be implemented by a Central Processing Unit (CPU), a Digital Signal Processor (DSP) or a Field Programmable Gate Array (FPGA) in the terminal.

The foregoing are only preferred embodiments of the present disclosure, but are not intended to limit the protection scope of the present disclosure.

What is claimed is:

1. A screen edge touch control optimization method, comprising:
setting a screen edge touch control optimization region; and
when it is determined that a touch point detected currently is located in the screen edge touch control optimization region, prohibiting a touch control event corresponding to the detected touch point from being reported to an application layer.

2. The screen edge touch control optimization method according to claim 1, further comprising: before it is determined that the touch point detected currently is located in the screen edge touch control optimization region, determining that a screen edge touch control optimization function is turned on.

3. The screen edge touch control optimization method according to claim 1, further comprising: when it is determined that the touch point detected currently is located in the screen edge touch control optimization region,
determining that an application activated currently is a preset application that needs to perform screen edge touch control optimization processing.

4. The screen edge touch control optimization method according to claim 1, wherein the step of setting the screen edge touch control optimization region comprises: setting more than one region with different areas in the screen as touch control optimization regions.

5. The screen edge touch control optimization method according to claim 3, further comprising: when it is determined that the application activated currently is not the preset application that needs to use the screen edge touch control optimization function, reporting the touch control event corresponding to the detected touch point to the application layer to be processed.

6. A screen edge touch control optimization device, the device comprising: a touch control optimization function setting unit and a touch control optimization execution unit, wherein
the touch control optimization function setting unit is configured to set a screen edge touch control optimization region; and
the touch control optimization execution unit is configured to, when it is determined that a touch point detected currently is located in the screen edge touch control optimization region, prohibit a touch control event corresponding to the detected touch point from being reported to an application layer.

7. The screen edge touch control optimization device according to claim 6, wherein the touch control optimization function setting unit is further configured to set more than one region with different areas in the screen as touch control optimization regions.

8. The screen edge touch control optimization device according to claim 6, wherein the touch control optimization function setting unit is further configured to trigger the touch control optimization execution unit when it is determined that a screen edge touch control optimization function is turned on.

9. The screen edge touch control optimization device according to claim 6, wherein
the touch control optimization function setting unit is further configured to set an application that needs to perform screen edge touch control optimization processing; and
the touch control optimization execution unit is further configured to, when it is determined that the touch point detected currently is located in the screen edge touch control optimization region, determine that a current application is the application that needs to perform the screen edge touch control optimization processing.

10. The screen edge touch control optimization device according to claim 6, wherein
the touch control optimization execution unit is further configured to, when it is determined that an application activated currently is not a preset application that needs to use screen edge touch control optimization function, report the touch control event corresponding to the detected touch point to the application layer to be processed.

11. The screen edge touch control optimization device according to claim 6, wherein the touch control optimization function setting unit comprises:
a touch control optimization function setting sub-unit, configured to set whether to turn on a screen edge touch control optimization function;
a touch control optimization region setting sub-unit, configured to set the screen edge touch control optimization region; and
a touch control optimization application setting sub-unit, configured to set an application that needs to perform screen edge touch control optimization processing.

12. A terminal, comprising a screen edge touch control optimization device, wherein the screen edge touch control optimization device comprises a touch control optimization function setting unit and a touch control optimization execution unit,
wherein the touch control optimization function setting unit is configured to set a screen edge touch control optimization region; and
the touch control optimization execution unit is configured to, when it is determined that a touch point detected currently is located in the screen edge touch control optimization region, prohibit a touch control event corresponding to the detected touch point from being reported to an application layer.

13. The screen edge touch control optimization method according to claim 2, further comprising: when it is determined that the touch point detected currently is located in the screen edge touch control optimization region,
determining that an application activated currently is a preset application that needs to perform screen edge touch control optimization processing.

14. The screen edge touch control optimization method according to claim 13, further comprising: when it is determined that the application activated currently is not the preset application that needs to use the screen edge touch control optimization function, reporting the touch control event corresponding to the detected touch point to the application layer to be processed.

15. The screen edge touch control optimization device according to claim 8, wherein
the touch control optimization function setting unit is further configured to set an application that needs to perform screen edge touch control optimization processing; and
the touch control optimization execution unit is further configured to, when it is determined that the touch point detected currently is located in the screen edge touch control optimization region, determine that a current application is the application that needs to perform the screen edge touch control optimization processing.
